(19) United States
(12) Patent Application Publication
(10) Pub. No.: US 2024/0014672 A1
(43) Pub. Date: Jan. 11, 2024

(54) POWER SUPPLY DEVICE

(71) Applicant: Murata Manufacturing Co., Ltd., Nagaokakyo-shi (JP)

(72) Inventor: Yosuke ISHISAKA, Nagaokakyo-shi (JP)

(21) Appl. No.: 18/214,595

(22) Filed: Jun. 27, 2023

(30) Foreign Application Priority Data
Jul. 6, 2022 (JP) 2022-109158

(51) Int. Cl. H02J 7/00

(52) U.S. Cl. CPC H02J 7/00309; H02J 7/0047; H02J 7/007194; H02J 7/00712; H02J 2207/20

(57) ABSTRACT

A power supply device includes battery units connected in parallel and each including a secondary battery, temperature sensors to measure temperatures of the battery units, and a controller to control output currents from the battery units. The controller is configured or programmed to calculate, based on measurement results from the temperature sensors, output sustainable times during which the output currents are able to be output due to charge stored in the secondary batteries, and to perform control to decrease the output current from one of the battery units with a shortest output sustainable time.

### CROSS REFERENCE TO RELATED APPLICATIONS

This application claims the benefit of priority to Japanese Patent Application No. 2022-109158 filed on Jul. 6, 2022. The entire contents of this application are hereby incorporated herein by reference.

### BACKGROUND OF THE INVENTION

### 1. Field of the Invention

The present disclosure relates to a power supply device.

### 2. Description of the Related Art

A power supply system in which a battery unit and a load are connected in parallel to a power supply unit is disclosed in International Publication No. 2015/015570. The power supply system disclosed in International Publication No. 2015/015570 operates in a normal mode, a backup mode, or an assist mode. Thus, the amount of power assigned to a battery at the time of peak load can be appropriately controlled, without a complicated common control device or large-scale intercommunication means being provided.

### SUMMARY OF THE INVENTION

It is desirable that the battery unit used in the above-mentioned power supply system stop output after stored power is consumed. Furthermore, it is desirable that the battery unit include a protection circuit that stops output in accordance with an increase in temperature. However, even in the case where the battery unit including the above-mentioned protection circuit has stored power that can be output, output may be stopped by the protection circuit. Thus, there is a problem of not being able to efficiently operate stored power.

Accordingly, preferred embodiments of the present invention provide power supply devices that each achieve efficient operation of power stored in a battery unit.

A power supply device according to an aspect of a preferred embodiment of the present disclosure includes a plurality of battery units connected in parallel and each including a secondary battery, a plurality of temperature sensors to measure temperatures of the plurality of battery units, and a controller to control output currents from the plurality of battery units. The controller is configured or programmed to calculate, based on measurement results from the plurality of temperature sensors, output sustainable times during which the output currents are able to be output due to charge stored in the secondary batteries, and to perform control to decrease the output current from one of the plurality of battery units with a shortest output sustainable time.

Furthermore, a power supply device according to an aspect of a preferred embodiment of the present disclosure includes a plurality of battery units connected in parallel and each including a secondary battery, a plurality of temperature sensors to measure temperatures of the plurality of battery units, and a controller to control output currents from the plurality of battery units. The controller is configured or programmed to perform control to decrease the output current from one of the battery units with a highest measurement result among measurement results from the plurality of temperature sensors and to increase the output current from at least one of battery units other than the battery unit with the highest measurement result.

In power supply devices according to preferred embodiments of the present disclosure, efficient operation of power stored in a battery unit can be achieved.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram illustrating a power supply system according to a preferred embodiment of the present invention.

FIG. 2 is a block diagram illustrating configurations of battery units.

FIG. 3 is a block diagram illustrating, regarding a current balancing process, a configuration example in which the maximum current among output currents from a plurality of battery units is detected.

FIG. 4 is a waveform chart illustrating an output current adjusting operation of a battery unit.

FIG. 5 is a block diagram illustrating, regarding a current unbalancing process, a configuration example of control of a plurality of battery units.

FIG. 6 is a waveform chart illustrating an output current adjusting operation of a battery unit.

FIG. 7 is a waveform chart for explaining a process for estimating output stop time based on temperature.

FIG. 8 is a flowchart illustrating the flow of control of output currents from battery units.

FIG. 9 is a block diagram illustrating a power supply device according to a modification of a preferred embodiment of the present invention.

### DETAILED DESCRIPTION OF THE PREFERRED EMBODIMENTS

Hereinafter, power supply systems including power supply devices according to preferred embodiments of the present disclosure will be described with reference to accompanying drawings.

The accompanying drawings merely illustrate preferred embodiments of the present disclosure and are not intended to limit the present disclosure. The terms such as “first”, “second”, and “third” in the present disclosure are used to simply distinguish objects from each other and do not indicate ranking of the objects.

Detailed description provided below includes devices, systems, and methods that exemplify illustrative preferred embodiments of the present disclosure. The detailed description is merely provided for the purpose of explanation and is not intended to limit preferred embodiments of the present disclosure or limit application and use of the preferred embodiments. Hereinafter, preferred embodiments will be described.

### Schematic Configuration of Power Supply System

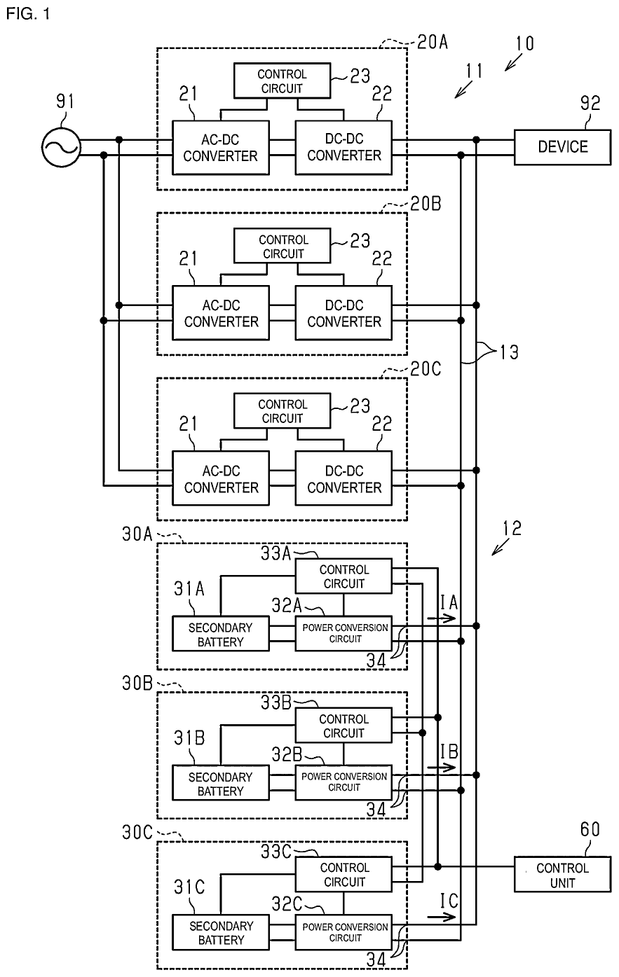

As illustrated in FIG. 1, a power supply system 10 includes a first power supply device 11 and a second power supply device 12. The first power supply device 11 is connected to an AC power supply 91. The AC power supply 91 is, for example, a commercial power system or the like. The first power supply device 11 is connected to power supply lines 13, and the power supply lines 13 are connected to a device 92. The device operates on DC voltage. The device 92 is, for example, a server, a storage, or the like in a data center or the like.

The first power supply device 11 includes power supply units 20A, 20B, and 20C. The power supply units 20A, 20B, and 20C each convert the AC voltage of the AC power supply 91 into a DC voltage on which the device 92 operates. Output voltages from the power supply units 20A, 20B, and 20C in the first power supply device 11 are supplied to the device 92 through the power supply lines 13.

The second power supply device 12 is configured to be capable of being connected to the power supply lines 13. The second power supply device 12 includes battery units (hereinafter, may be referred to as “BUs”) 30A, 30B, and 30C including secondary batteries (batteries) 31A, 31B, and 31C, respectively. The secondary batteries 31A, 31B, and 31C are batteries (secondary batteries) capable of being charged and discharged. The battery units 30A, 30B, and 30C charge the secondary batteries 31A, 31B, and 31C, respectively, by the output voltage from the first power supply device 11. The battery units 30A, 30B, and 30C also convert the voltages of the secondary batteries 31A, 31B, and 31C, respectively, into DC voltages on which the device 92 operates and outputting the DC voltages. The output voltages from the battery units 30A, 30B, and 30C are supplied to the device 92 through the power supply lines 13.

### First Power Supply Device

As illustrated in FIG. 1, the first power supply device 11 includes the three power supply units 20A, 20B, and 20C. The first power supply device 11 may include one, two, four, or more power supply units. Each of the power supply units 20A, 20B, and is connected to the AC power supply 91. Each of the power supply units 20A, 20B, and 20C is also connected to the device 92 through the power supply lines 13.

The power supply units 20A, 20B, and 20C have the same configuration. Each of the power supply units 20A, 20B, and 20C includes an AC-DC converter 21, a DC-DC converter 22, and a control circuit 23. The control circuit 23 controls the AC-DC converter 21 and the DC-DC converter 22. The AC-DC converter 21 converts the AC voltage of the AC power supply 91 into a DC voltage. The DC-DC converter 22 converts the DC voltage output from the AC-DC converter 21 into a DC voltage corresponding to the device 92.

The power supply units 20A, 20B, and 20C have output characteristics (droop characteristics) in which an output voltage varies according to an output current. The power consumption of the device 92 such as a server varies according to the amount of information processing. The power consumption of the device 92 is a load with respect to the power supply units 20A, 20B, and 20C. Thus, the load of the power supply units 20A, 20B, and 20C varies according to an operation of the device 92.

### Second Power Supply Device

The second power supply device 12 includes the three battery units 30A, 30B, and 30C and a control unit 60. The second power supply device 12 may include one, two, four, or more battery units.

The battery units 30A, 30B, and 30C have the same configuration. Each of the battery units 30A, 30B, and 30C is connected to the device 92 through the power supply lines 13. Thus, the battery units 30A, 30B, and 30C can be considered to be connected in parallel to the power supply units 20A, 20B, and 20C, respectively. The power supply units 20A, 20B, and 20C are connected to the device 92. Thus, the battery units 30A, 30B, and can be considered to be connected in parallel to the device 92.

The battery units 30A, 30B, and 30C are connected to the control unit 60. Each of the battery units 30A, 30B, and 30C is configured to be capable of communicating with the control unit 60. The control unit 60 is configured to be capable of transmitting various instructions to the battery units 30A, 30B, and 30C.

### Configurations of Battery Units

The battery units 30A, 30B, and 30C include the secondary batteries 31A, 31B, and 31C, power conversion circuits 32A, 32B, and 32C, and control circuits 33A, 33B, and 33C, respectively.

As described above, the battery units 30A, 30B, and 30C have the same configuration. Therefore, regarding configurations of the battery units 30A, 30B, and 30C, the configuration of the battery unit 30A will be described in detail, and explanation of the configurations of the battery units 30B and 30C will be omitted. Explanation including the configurations of the battery units 30B and 30C will be provided where necessary.

The secondary battery 31A of the battery unit 30A is a battery (secondary battery) capable of being charged and discharged. The secondary battery 31A is, for example, a lithium-ion battery. The power conversion circuit 32A is configured to be capable of converting terminal voltages of connection terminals 34 of the battery unit 30A. The connection terminals 34 are connected to the power supply lines 13. The power conversion circuit 32A is also configured to be capable of converting the voltage of the secondary battery 31A.

The power conversion circuit 32A generates a charging current for charging the secondary battery 31A based on the terminal voltages of the connection terminals 34 of the battery unit 30A. Furthermore, the power conversion circuit 32A converts the voltage of the secondary battery 31A into output voltages to be output from the connection terminals 34. The power conversion circuit 32A is configured to be, for example, a bidirectional DC-DC converter. The control circuit 33A controls the power conversion circuit 32A.

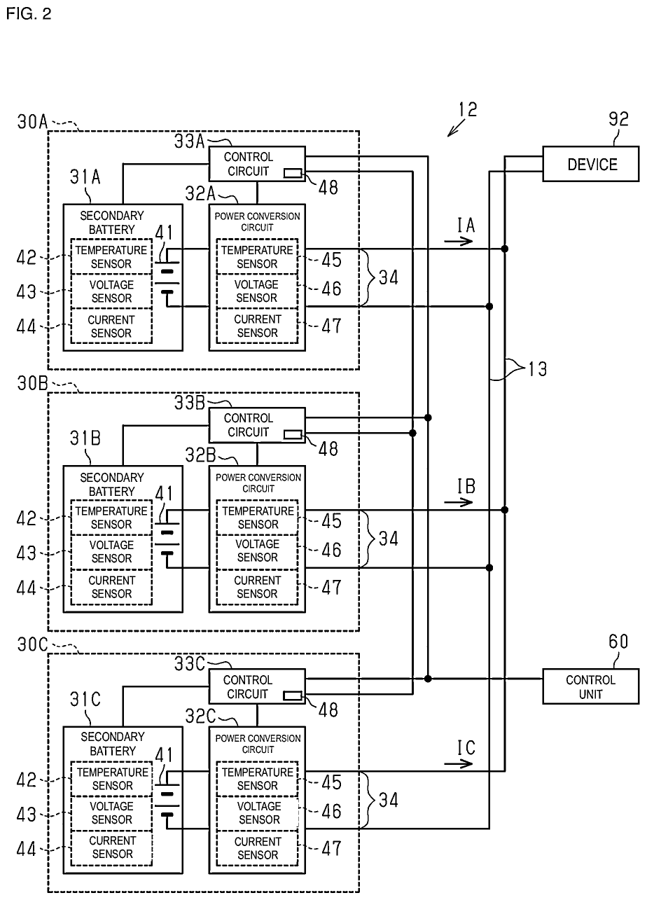

As illustrated in FIG. 2, the secondary battery 31A includes a plurality of battery cells 41. A temperature sensor 42, a voltage sensor 43, and a current sensor 44 are provided in the secondary battery 31A.

The temperature sensor 42 is configured to be capable of measuring the temperature of the secondary battery 31A. The temperature sensor 42 is configured to be capable of measuring the temperature of a predetermined battery cell 41 among the plurality of battery cells 41. The predetermined battery cell 41 may be a battery cell that has the highest temperature during operation of the battery unit 30A among the plurality of battery cells 41. The temperature sensor 42 may be arranged near the predetermined battery cell 41.

A plurality of temperature sensors 42 may be provided in the secondary battery 31A. One of the plurality of temperature sensors 42 is arranged so as to be capable of measuring the temperature of a battery cell that has the lowest temperature during operation of the battery unit 30A among the plurality of battery cells 41 of the secondary battery 31A. Based on the temperature measured by the temperature sensor 42 arranged as described above, operation at a low temperature may be restricted.

The voltage sensor 43 is configured to be capable of measuring the output voltage from the secondary battery 31A. The output voltage from the secondary battery 31A is, for example, a potential difference (voltage between terminals) between a positive terminal and a negative terminal of the secondary battery 31A. The voltage sensor 43 may be configured to be capable of measuring the terminal voltage of at least one of the plurality of battery cells 41 of the secondary battery 31A.

The current sensor 44 is configured to be capable of measuring a current with respect to the secondary battery 31A. The current with respect to the secondary battery 31A includes a current (charging current) flowing from the power conversion circuit 32A toward the secondary battery 31A and a current (discharging current) flowing from the secondary battery 31A toward the power conversion circuit 32A. The current sensor 44 may be configured to be capable of measuring at least a discharging current. A current sensor capable of measuring a discharging current and a current sensor capable of measuring a charging current may be provided.

A temperature sensor 45, a voltage sensor 46, and a current sensor 47 are provided in the power conversion circuit 32A.

The temperature sensor 45 is configured to be capable of measuring the temperature of the power conversion circuit 32A. The temperature sensor 45 is configured to be capable of measuring the temperature of an electronic component in the power conversion circuit 32A. The temperature sensor 45 may be capable of measuring the temperature of a predetermined electronic component. The predetermined electronic component may be, for example, a transistor included in the power conversion circuit 32A.

The voltage sensor 46 is configured to be capable of measuring the terminal voltages of the connection terminals 34. The connection terminals 34 are connected to the power conversion circuit 32A. The power conversion circuit 32A generates a charging current to charge the secondary battery 31A based on the terminal voltages of the connection terminals 34. Thus, in a charging mode to charge the secondary battery 31A, the terminal voltages of the connection terminals 34 can be considered to be an input voltage to the power conversion circuit 32A and an input voltage to the battery unit 30A. Therefore, the voltage sensor 46 is configured to be capable of measuring the input voltage to the power conversion circuit 32A and the input voltage to the battery unit 30A in the charging mode.

Furthermore, the power conversion circuit 32A converts the voltage of the secondary battery 31A into output voltages to be output from the connection terminals 34. Thus, in a discharging mode to discharge from the secondary battery 31A, the terminal voltages from the connection terminals 34 can be considered to be an output voltage from the power conversion circuit 32A and an output voltage from the battery unit 30A. Therefore, the voltage sensor 46 is configured to be capable of measuring the output voltage from the power conversion circuit 32A and the output voltage from the battery unit 30A in the discharging mode.

The current sensor 47 is configured to be capable of measuring currents flowing in the connection terminals 34.

In the charging mode, currents flowing from the connection terminals 34 toward the power conversion circuit 32A flow in the connection terminals 34. These currents can be considered to be an input current to the power conversion circuit 32A and an input current to the battery unit 30A in the charging mode. The current sensor 47 is configured to be capable of measuring the input current to the power conversion circuit 32A and the input current to the battery unit 30A in the charging mode.

Furthermore, in the discharging mode, currents flowing from the power conversion circuit 32A toward the connection terminals 34 flow in the connection terminals 34. These currents can be considered to be an output current from the power conversion circuit 32A and an output current from the battery unit 30A in the discharging mode. The current sensor 47 is configured to be capable of measuring the output current from the power conversion circuit 32A and the output current from the battery unit 30A in the discharging mode.

### Function of Control Circuit: Protection Function

The control circuit 33A monitors the state of the secondary battery 31A based on measurement results from the temperature sensor 42, the voltage sensor 43, and the current sensor 44. The state of the secondary battery 31A includes excessive temperature rise, excessive temperature drop, excessive current discharge, excessive charge, state of charge (SOC), and state of health (SOH). The control circuit 33A monitors, by using the temperature sensor 42, the cell temperature Tcell of the secondary battery 31A. The control circuit 33A monitors, by using the current sensor 44, the amount of current discharged from the secondary battery 31A. Furthermore, the control circuit 33A monitors the state of charge (SOC) and the state of health (SOH) by accumulating the amount of charge and discharge (charge quantity) of the secondary battery 31A. The control circuit 33A controls the power conversion circuit 32A in such a manner that various parameters being monitored are not equal to or more than limit values or are not less than or equal to limit values.

For example, the control circuit 33A detects the cell temperature Tcell of the secondary battery 31A based on a measurement result from the temperature sensor 42. When the cell temperature Tcell is equal to or more than a discharge stop protection value Tcell_max, the control circuit 33A controls the power conversion circuit 32A to stop the secondary battery 31A from discharging. Thus, the control circuit 33A protects the secondary battery 31A so that excessive temperature rise is prevented.

Furthermore, the control circuit 33A detects a secondary battery voltage value Vdcdc_in of the secondary battery 31A based on a measurement result from the voltage sensor 43. When the secondary battery voltage value Vdcdc_in drops to or below a discharge stop protection voltage Vdcdc_min, the control circuit 33A controls the power conversion circuit 32A to stop the secondary battery 31A from discharging. The discharge stop protection voltage Vdcdc_min may be set to, for example, about a value half the voltage value of full charge of the secondary battery 31A. Thus, the control circuit 33A protects the secondary battery 31A from excessive discharge.

Furthermore, the control circuit 33A detects Joule loss Ploss of the secondary battery 31A based on a measurement result from the current sensor 44. When the Joule loss Ploss reaches a discharge stop protection value or more, the control circuit 33A controls the power conversion circuit 32A to stop the secondary battery 31A from discharging.

Furthermore, the control circuit 33A monitors the state of the power conversion circuit 32A based on measurement results from the temperature sensor 45, the voltage sensor 46, and the current sensor 47. The state of the power conversion circuit 32A includes excessive temperature rise, excessive temperature drop, excessive current inflow, excessive current outflow, and input voltage abnormality (excessive voltage rise and excessive voltage drop). The control circuit 33A monitors, using the temperature sensor 45, the temperature of the power conversion circuit 32A. The control circuit 33A monitors, using the current sensor 47, the amount of input current to the power conversion circuit 32A and the amount of output current from the power conversion circuit 32A. Furthermore, the control circuit 33A monitors, using the voltage sensor 46, the input voltage to the power conversion circuit 32A. The control circuit 33A controls the power conversion circuit 32A in such a manner that various parameters being monitored are not equal to or more than limit values or are not less than or equal to limit values.

### Function of Control Circuit: Adjustment of Current Balance

Furthermore, the control circuit 33A compares the amount of output current from the battery unit 30A with the amounts of output currents from the other battery units 30B and 30C that are connected in parallel to the battery unit 30A. The control circuit 33A controls the power conversion circuit 32A in the battery unit 30A based on comparison results. Thus, the control circuits 33A, 33B, and 33C in the battery units 30A, 30B, and 30C operate in such a manner that output currents IA, IB, and IC from the battery units 30A, 30B, and 30C are equal.

More particularly, as illustrated in FIG. 2, the control circuits 33A, 33B, and 33C in the battery units 30A, 30B, and 30C are connected to one another. Each of the control circuits 33A, 33B, and 33C is configured to detect the maximum current value among the output current values from the battery units 30A, 30B, and 30C. The control circuits 33A, 33B, and 33C each include a memory unit 48. A comparison difference target value is stored in the memory unit 48. The control circuits 33A, 33B, and 33C control the power conversion circuits 32A, 32B, and 32C, respectively, to adjust currents to be output from the battery units 30A, 30B, and 30C, respectively, based on the detected maximum current value, output current values from the battery units 30A, 30B, and 30C, and comparison difference target values.

Comparison difference target values are provided as control instructions from the control unit 60 to the control circuits 33A, 33B, and 33C and are stored into the memory units 48. The comparison difference target values are set as proportions (%) of differences between output current values from the battery units 30A, 30B, and 30C and the maximum current value with respect to the maximum current value. The control circuit 33A calculates a current difference value between the maximum current value and the output current value from the own unit. Then, the control circuits 33A, 33B, and 33C control the power conversion circuits 32A, 32B, and 32C in such a manner that the proportions of the current difference values with respect to the maximum current value are less than or equal to comparison difference target values. A comparison difference target value is not necessarily a proportion and may be a fixed value (for example, 5 ampere (A)).

For example, the comparison difference target values of the control circuits 33A, 33B, and 33C are the same values. In this case, the control circuits 33A, 33B, and 33C control the power conversion circuits 32A, 32B, and 32C, respectively, in such a manner that current difference values of the own units are less than or equal to the same comparison difference target value. Thus, the battery units 30A, 30B, and 30C output same output currents. The comparison difference target value is represented as a range of difference (the maximum value and the minimum value of a difference). A comparison difference target value is, for example, about ±5%.

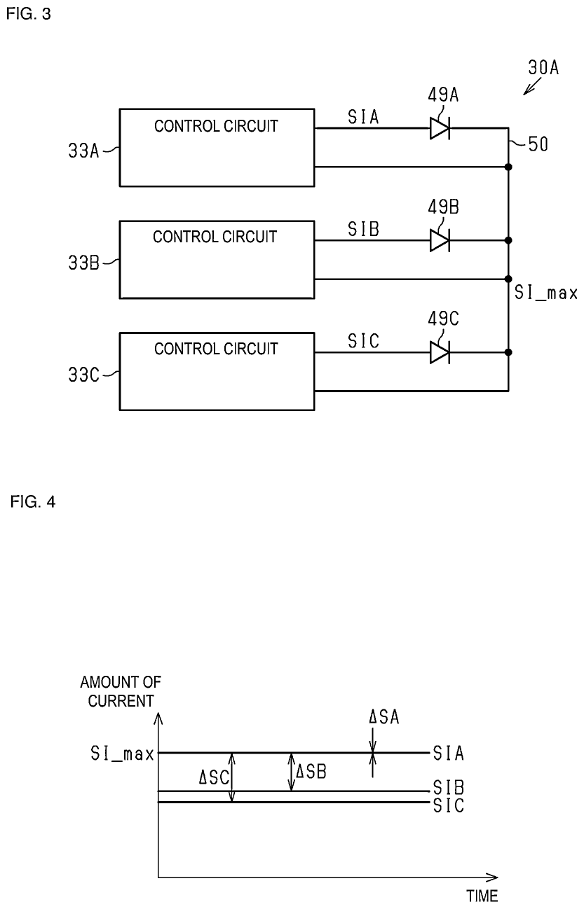

FIG. 3 is a block diagram illustrating a configuration example in which the maximum current value among output current values from a plurality of battery units is detected.

The control circuits 33A, 33B, and 33C in the battery units 30A, 30B, and 30C are connected to anodes of diodes 49A, 49B, and 49C, respectively, and cathodes of the diodes 49A, 49B, and 49C are connected to a common signal line 50. The common signal line 50 is connected to the control circuits 33A, 33B, and 33C.

The control circuits 33A, 33B, and 33C output signals SIA, SIB, and SIC indicating the amounts of output currents IA, IB, and IC, respectively (see FIG. 2). In this example, the control circuits 33A, 33B, and 33C output the signals SIA, SIB, and SIC, respectively, at signal levels (voltages) corresponding to the amounts of currents. In this example, the signal levels of the signals SIA, SIB, and SIC are represented by the same signs as the signals SIA, SIB, and SIC. The signal level (maximum voltage) of the common signal line 50 is set to SI_max.

The control circuits 33A, 33B, and 33C receive the maximum level SI_max. The control circuits 33A, 33B, and 33C detect level differences between the levels of the signals SIA, SIB, and SIC from the control circuits 33A, 33B, and 33C and the maximum level SI_max. Then, the control circuits 33A, 33B, and 33C control the power conversion circuits 32A, 32B, and 32C, respectively, in such a manner that the level differences are less than or equal to the comparison difference target value.

FIG. 4 is a waveform chart illustrating an example of the signals SIA, SIB, and SIC corresponding to output currents from the battery units 30A, 30B, and 30C, respectively. In FIG. 4, the horizontal axis represents time, and the vertical axis represents signal level. In the example illustrated in FIG. 4, the signals levels decrease in the order of the signal SIA of the control circuit 33A, the signal SIB of the control circuit 33B, and the signal SIC of the control circuit 33C illustrated in FIG. 3. That is, the maximum level SI_max is the signal level of the signal SIA of the control circuit 33A.

The control circuits 33A, 33B, and 33C detect differences ΔSA, ΔSB, and ΔSC between the maximum level SI_max and the signal levels of the signals SIA, SIB, and SIC, respectively. Then, the control circuits 33A, 33B, and 33C compare the detected level differences ΔSA, ΔSB, and ΔSC with corresponding comparison difference target values. The control circuits 33A, 33B, and 33C control the power conversion circuits 32A, 32B, and 32C, respectively, in such a manner that the detected level differences ΔSA, ΔSB, and ΔSC are less than or equal to the comparison difference target values.

In FIG. 4, the level differences ΔSB and ΔSC are larger than the comparison difference target values. In FIG. 4, the maximum level SI_max is equal to the level of the signal SIA. Thus, because the level difference ΔSA is “0” and is smaller than the comparison difference target value, the control circuit 33A maintains the output current IA. The control circuit 33B detects the level difference ΔSB. The control circuit 33B controls the power conversion circuit 32B in such a manner that the level difference ΔSB is smaller than or equal to the comparison difference target value (within the range), that is, the amount of the output current IB is increased. Furthermore, the control circuit 33C detects the level difference ΔSC between the maximum level SI_max and the signal SIC. The control circuit 33C controls the power conversion circuit 32C in such a manner that the level difference ΔSC is smaller than or equal to the comparison difference target value (within the range), that is, the amount of the output current IC is increased. Due to the control described above, the amounts of the output currents IB and IC from the battery units 30B and 30C increase, and the signal levels of the signals SIB and SIC thus increase. Therefore, all the amounts of the output currents IA, IB, and IC from the battery units 30A, 30B, and 30C become equal. That is, the output currents IA, IB, and IC from the battery units 30A, 30B, and 30C are made equal.

### Output Sustainable Time and Current Unbalancing

The control circuit 33A calculates an output sustainable time thold. The output sustainable time thold is an estimated remaining time during which the output current IA from the battery unit 30A can be maintained. The control circuit 33A stops the output current IA from the battery unit 30A by a protection function with respect to an internal factor of the battery unit 30A. The protection function includes a temperature protection function based on the cell temperature Tcell of the secondary battery 31A, a temperature protection function based on a circuit temperature Tdcdc of the power conversion circuit 32A, and a protection function based on the state of charge of a secondary battery.

The protection function based on the cell temperature Tcell is provided to stop output of the output current IA when the cell temperature Tcell of the secondary battery 31A reaches a discharge stop cell temperature (high temperature protection) Tcell_max or higher.

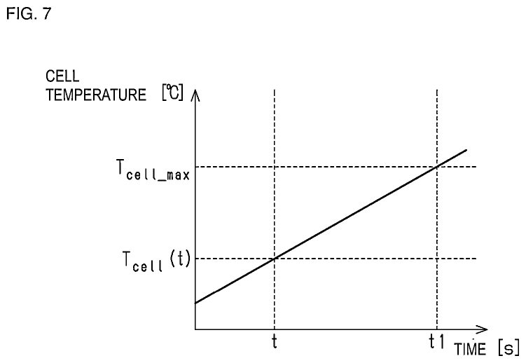

As illustrated in FIG. 7, the control circuit 33A measures the cell temperature Tcell(t) at time t. The time t1 at which the cell temperature Tcell reaches the discharge stop protection value Tcell_max can be calculated based on the cell temperature Tcell(t) and a temperature increase temporal gradient ΔTcell. The calculated difference between the time t1 and the current time t is an estimation time tcell(t) at the current time t.

The control circuit 33A calculates the temperature increase temporal gradient ΔTcell (Ibatt, SOH) [° C./sec] based on a discharging current Ibatt(t) from the secondary battery 31A and the state of health (SOH) of the secondary battery 31A. The temperature increase temporal gradient ΔTcell may be calculated from cell temperatures Tcell measured a plurality of times. Furthermore, the estimation time tcell may be obtained based on the cell temperature Tcell or the like with reference to a table stored in the control circuit 33A.

The control circuit 33A calculates, based on the temperature increase temporal gradient ΔTcell, the estimation time tcell up to the time when the cell temperature Tcell reaches the discharge stop protection value Tcell_max. The estimation time tcell may be obtained using an equation provided below.

$${t}_{cell} [ s ] = \frac{{T}_{cell \_ max - {T}_{cell} ( t ) [ K ]}}{Δ {T}_{cell} ( {I}_{batt} , SOH ) [ K / s ]}$$

In the above equation, Tcell_max represents the discharge stop cell temperature (protection threshold), Tcell(t) represents the cell temperature at time t, and ΔTcell (Ibatt, SOH) represents the temperature increase temporal gradient of the secondary battery 31A.

The protection function based on the circuit temperature Tdcdc is provided to stop output of the output current IA when the circuit temperature Tdcdc of the power conversion circuit 32A reaches the temperature increase protection value Tdcdc_max or higher.

The control circuit 33A calculates the estimation time tdcdc up to the time when the circuit temperature Tdcdc reaches the temperature increase protection value Tdcdc_max. The estimation time tdcdc may be obtained using an equation provided below.

$${t}_{dcdc} [ s ] = \frac{{T}_{dcdc \_ max} - {T}_{dcdc} ( t ) [ K ]}{Δ {T}_{dcdc} ( {I}_{batt} , SOH ) [ K / s ]}$$

In the above equation, Tdcdc_max represents the circuit temperature increase protection value (protection threshold), Tdcdc(t) represents the circuit temperature at time t, and ΔTdcdc (Ibatt, SOH) represents the temperature increase temporal gradient of the power conversion circuit 32A.

The protection function based on the state of charge is provided to stop output of the output current IA when the stored charge quantity Qbatt of the secondary battery 31A drops to or below a lower limit value. The control circuit 33A calculates an estimation time tsoc up to the time when the charge quantity of the secondary battery 31A reaches the lower limit value. The estimation time tsoc may be calculated using an equation provided below.

$${t}_{SOC} [ s ] = \frac{{Q}_{batt} ( SOC ) - {Q}_{{batt}_{min - limit}} [ C ]}{{I}_{batt} [ C / s ]}$$

In the above equation, Qbatt (SOC) represents the stored charge quantity of the secondary battery 31A, Qbatt-min limit represents a charge quantity lower limit value (protection threshold), and Ibatt represents the amount of discharging current from the secondary battery.

The control circuit 33A sets the minimum value among the estimation times tcell, tdcdc, and tsoc calculated as described above as the output sustainable time thold. The control circuit 33A transmits the output sustainable time thold to the control unit 60.

The control circuit 33A transmits the secondary battery voltage value Vdcdc_in of the secondary battery 31A obtained by the voltage sensor 43 to the control unit 60. The control circuit 33A calculates an internal resistance (current resistance component) DCR of the secondary battery 31A based on the state of health SOH of the secondary battery 31A and the cell temperature Tcell of the secondary battery 31A. The control circuit 33A calculates loss (Joule loss) Ploss of the secondary battery 31A based on the internal resistance DCR of the secondary battery 31A and the square of the discharging current Ibatt of the secondary battery 31A, as represented by an equation provided below.

Pₗₒₛₛ[W]=DCR(SOH,T_{cell})I_{batt}²

The control circuit 33A transmits the Joule loss Ploss to the control unit 60. In the above equation, DCR (SOH, Tcell) represents the internal resistance of a secondary battery, and Ibatt represents the amount of discharging current from the secondary battery.

The control unit 60 receives the output sustainable time thold, the secondary battery voltage value Vdcdc_in, and the Joule loss Ploss from each of the control circuits 33A, 33B, and 33C in the battery units 30A, 30B, and 30C.

The control unit 60 compares the output sustainable times thold of the battery units 30A, 30B, and 30C. In the case where there is a difference among the output sustainable times thold of the battery units 30A, 30B, and 30C, the control unit 60 adjusts the amounts of output currents from the battery units 30A, and 30C in such a manner that the output sustainable times thold are equal. For example, in the case where the difference between output sustainable times thold of two battery units is equal to or more than a predetermined time (for example, ten seconds), the control unit 60 determines that there is a difference between the output sustainable times thold. In the case where the difference between output sustainable times thold of two battery units is equal to or more than a predetermined proportion (for example, about 10%) of one output sustainable time thold, it may be determined that there is a difference between the output sustainable times thold.

The control unit 60 specifies a battery unit with a short output sustainable time thold as a target battery unit. The control unit 60 increases a comparison difference target value of the target battery unit. The comparison difference target value is a range set so that the amounts of output currents from the battery units 30A, 30B, and 30C are made equal. The control unit 60 increases the comparison difference target value, that is, expands the range. Thus, the amount of output current from the target battery unit becomes smaller than the amounts of output currents from the other battery units. That is, the amounts of output currents from the battery units 30A, 30B, and 30C are unbalanced.

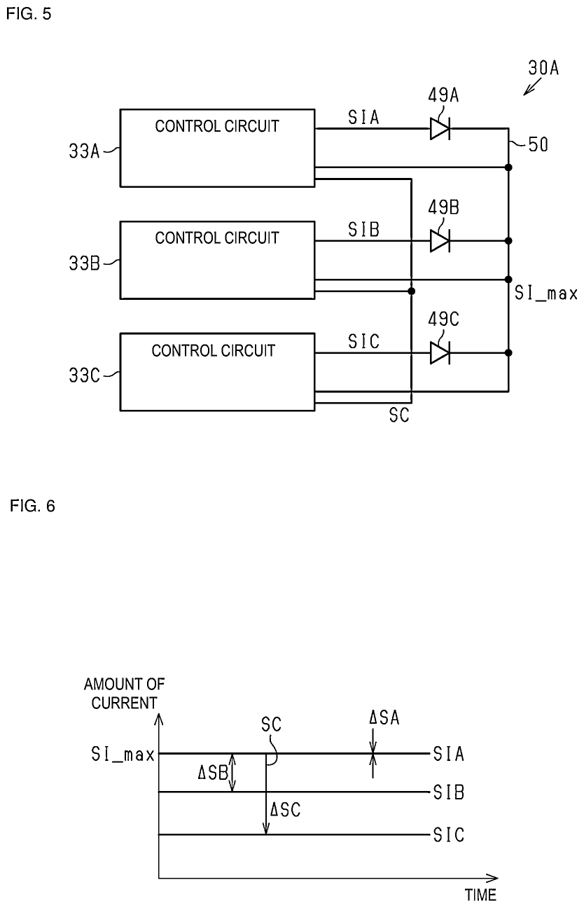

FIG. 5 is a block diagram for explaining current adjustment in the case where there is a difference in cell temperature Tcell. FIG. 6 is a waveform chart illustrating an example of the signals SIA, SIB, and SIC corresponding to output currents from the battery units 30A, 30B, and 30C, respectively.

For example, the cell temperatures Tcell of the secondary batteries 31A, 31B, and 31C illustrated in FIG. 2 are approximately “40° C.”, “40° C.”, and “50° C.”, respectively. The control circuits 33A, 33B, and 33C transmit output sustainable times thold corresponding to the cell temperatures Tcell to the control unit 60. In this example, the output sustainable time thold of the control circuit 33C is shorter than the output sustainable times thold of the other control circuits 33A and 33B.

The control unit 60 detects a difference among the output sustainable times thold of the control circuits 33A, 33B, and 33C. Then, based on the difference among the output sustainable times thold, the control unit 60 transmits an instruction SC to a control circuit to decrease the output current. In this case, the control unit 60 transmits a comparison difference target value (instruction SC) to the control circuit 33C with a short output sustainable time thold so that the output current IC is decreased. The control circuit 33C decreases the output current IC in accordance with the comparison difference target value, as illustrated in FIG. 6.

In a target battery unit, a decrease in the amount of output current means slowing increases in the cell temperature Tcell of a secondary battery and the temperature of a power conversion circuit and slowing a decrease in the stored charge quantity of the secondary battery. Thus, in the target battery unit, the output sustainable time thold can be extended to be closer to or equal to output sustainable times thold of the other battery units. Therefore, the output sustainable time thold of the second power supply device 12 can be extended.

In the case where there is no difference among the output sustainable times thold of the battery units 30A, 30B, and 30C, the control unit 60 compares the secondary battery voltage values Vdcdc_in of the battery units 30A, 30B, and 30C. In the case where there is a difference among the secondary battery voltage values Vdcdc_in of the battery units 30A, 30B, and 30C, the control unit 60 controls the control circuits 33A, 33B, and 33C in the battery units 30A, 30B, and 30C so that the amount of output current from a target battery unit is decreased, as with the case of the output sustainable time thold mentioned above.

In the case where a secondary battery voltage value Vdcdc_in is decreased to a value below a reference value, the control unit 60 may compare the secondary battery voltage values Vdcdc_in of the battery units 30A, 30B, and 30C. The reference value may be set to a value between voltage values at the time when the secondary batteries 31A, 31B, and 31C are fully charged and the discharge stop protection voltage Vdcdc_min. The reference value is, for example, about eighty percent of the voltage value at the time when the secondary batteries 31A, 31B, and 31C are fully charged.

In the case where there is no difference among the secondary battery voltage values Vdcdc_in of the battery units 30A, 30B, and 30C, the control unit 60 compares the Joule losses Ploss of the battery units 30A, 30B, and 30C. In the case where there is a difference (for example, a difference of 10 W or more) among the Joule losses Ploss of the battery units 30A, 30B, and 30C, the control unit 60 controls the control circuits 33A, 33B, and 33C in the battery units 30A, 30B, and 30C so that the amount of output current from a target battery unit is decreased, as with the case of the output sustainable time thold or the secondary battery voltage value Vdcdc_in mentioned above.

### Number of Target Battery Units

In this preferred embodiment, the second power supply device 12 including the three battery units 30A, 30B, and 30C is illustrated. In the second power supply device 12, one of the three battery units 30A, 30B, and 30C is specified as a target. The number of target battery units may be set in association with the number of battery units of a power supply device. For example, the number of target battery units may be set to half or below half the number of battery units of a power supply device.

### Adjustment of Currents of Battery Units

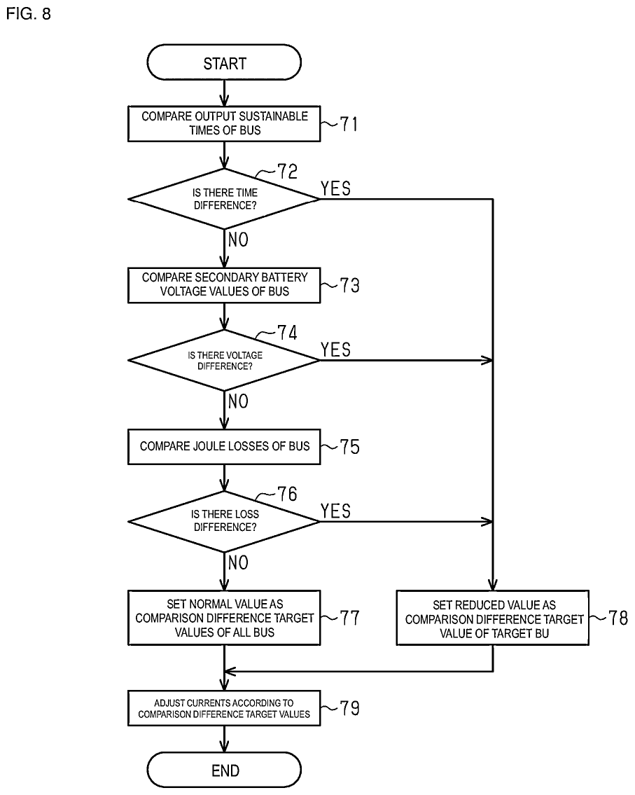

Adjustment of output currents from the battery units 30A, 30B, and 30C will be described with reference to a flowchart illustrated in FIG. 8.

FIG. 8 illustrates a process that is a part of a process performed by the second power supply device 12 illustrated in FIGS. 1 and 2, more particularly, the control circuits 33A, 33B, and 33C in the battery units 30A, 30B, and 30C and the control unit 60, and relates to the setting of comparison difference target values to adjust output currents from the battery units 30A, 30B, and 30C. The control unit 60 and the control circuits 33A, 33B, and 33C repeat the process illustrated in FIG. 8 at predetermined intervals. For example, the control unit 60 and the control circuits 33A, 33B, and 33C repeat the process illustrated in FIG. 8 every five seconds. Intervals at which the process is repeated may be changed in an appropriate manner.

In step 71 illustrated in FIG. 8, the control unit 60 compares output sustainable times thold received from the control circuits 33A, 33B, and 33C in the battery units 30A, 30B, and 30C.

In step 72, in the case where there is a difference among the output sustainable times thold of the battery units 30A, 30B, and 30C (YES), the process proceeds to step 78. In the case where there is no difference (NO), the process proceeds to step 73.

In step 73, the control unit 60 compares secondary battery voltage values Vdcdc_in received from the control circuits 33A, 33B, and 33C in the battery units 30A, 30B, and 30C.

In step 74, in the case where there is a difference among the secondary battery voltage values Vdcdc_in of the battery units 30B, and 30C (YES), the process proceeds to step 78. In the case where there is no difference (NO), the process proceeds to step 75.

In step 75, the control unit 60 compares Joule losses Ploss received from the control circuits 33A, 33B, and 33C in the battery units 30A, 30B, and 30C.

In step 76, in the case where there is a difference among the Joule losses Ploss of the battery units 30A, 30B, and 30C (YES), the process proceeds to step 78. In the case where there is no difference (NO), the process proceeds to step 77.

In step 77, normal values are set as comparison difference target values of all the battery units (BUs). The normal values are values set so that the output currents IA, IB, and IC from all the battery units 30A, 30B, and 30C are made equal and may be set to, for example, about ±5(%).

In step 78, a reduced value is set as the comparison difference target value of a target battery unit (BU). The reduced value is set to a predetermined value (for example, about −20%). The reduced value may be set based on the difference in output sustainable time thold, the difference in secondary battery voltage value Vdcdc_in, or the difference in Joule loss Ploss described above.

In step 79, the control circuits 33A, 33B, and 33C in the battery units 30A, 30B, and 30C control the output currents IA, IB, and IC from the battery units 30A, 30B, and 30C based on the received comparison difference target values.

Adjustment of currents in step 79 includes decreasing an output current from the target battery unit and increasing an output current from a non-target battery unit. An increase in an output current from a non-target battery unit can compensate for a decrease in the output current from the target battery unit. That is, as adjustment of currents, control is performed in such a manner that an output current from a target battery unit is decreased and the decrease in the output current is compensated for by increasing an output current from a non-target battery unit.

For example, the battery unit 30A is specified as a target battery unit. The output current IA from the battery unit is decreased by about 2 A. Then, the output currents from the battery units 30B and 30C, which are non-target battery units, are adjusted in such a manner that the output currents IB and IC from the battery units 30B and 30C are increased by about 2 A in total. As an adjustment method, for example, each of the output current IB from the battery unit 30B and the output current IC from the battery unit 30C is increased by about 1 A. Alternatively, for example, one of the output current IB from the battery unit 30B and the output current IC from the battery unit 30C is increased by about 1.5 A and the other one of the output current IB and the output current IC is increased by about 0.5 A. Alternatively, only one of the output current IB from the battery unit 30B and the output current IC from the battery unit 30C is increased by about 2 A. With this configuration, supplying electric power required by a load (server or the like) and increasing output sustainable time can be achieved at the same time.

An upper limit may be given to the output currents IA, IB, and IC from the battery units 30A, 30B, and 30C. The upper limit represents, for example, the maximum values of rated currents defined for the battery units 30A, 30B, and 30C, and is, for example, about 60 A. In the case where there is a battery unit that exceeds the upper limit of output current due to the above-mentioned control, target current values for all the battery units may be set to normal values, instead of increasing an output current, and the battery units 30A, 30B, and 30C may be controlled in such a manner that output currents from all the battery units are equal.

The control circuits 33A, 33B, and 33C and the control unit 60 in the second power supply device 12 repeat the processing of steps 71 to 79 at a predetermined period. The predetermined period may be set to, for example, about five seconds. Thus, communication is performed between the control unit 60 and the control circuits 33A, 33B, and 33C in the battery units 30A, 30B, and 30C at the predetermined period. Furthermore, comparison difference target values for the control circuits 33A, 33B, and 33C are set by the control unit 60 at the predetermined period.

### Operation

Next, operation of the second power supply device 12 configured as described above will be described.

The second power supply device 12 includes the three battery units 30A, 30B, and 30C that are connected in parallel and the control unit 60 that is connected to the battery units 30A, 30B, and 30C. The battery units 30A, 30B, and 30C include the secondary batteries 31A, 31B, and 31C, the power conversion circuits 32A, 32B, and 32C, and the control circuits 33A, 33B, and 33C, respectively. In each of the secondary batteries 31A, 31B, and 31C, the temperature sensor 42, the voltage sensor 43, and the current sensor 44 are provided. In each of the power conversion circuits 32A, 32B, and 32C, the temperature sensor 45, the voltage sensor 46, and the current sensor 47 are provided.

The control circuits 33A, 33B, and 33C output the signals SIA, SIB, and SIC indicating the amounts of the output currents IA, IB, and IC from the battery units 30A, 30B, and 30C, respectively. Furthermore, the control circuits 33A, 33B, and 33C receive the signal SI_max indicating the maximum value of the signals SIA, SIB, and SIC. Then, the control circuits 33A, 33B, and 33C control the power conversion circuits 32A, 32B, and 32C, respectively, in such a manner that level differences between the signals SIA, SIB, and SIC and the signal SI_max are less than or equal to comparison difference target values. Thus, the control circuits 33A, 33B, and 33C control the power conversion circuits 32A, 32B, and 32C in such a manner that the output currents IA, IB, and IC from the battery units 30A, 30B, and 30C are equal. As described above, the output currents IA, IB, and IC from the battery units 30A, 30B, and 30C are made equal. Thus, concentration of load on one or some of the battery units 30A, 30B, and 30C can be prevented, and excessive current in the battery units 30A, 30B, and 30C can be prevented.

The battery units 30A, 30B, and 30C in which the secondary batteries 31A, 31B, and 31C are mounted supply high output currents IA, IB, and IC in the range of several kW to several tens of kW to the device 92, for example. This causes significant increases in the temperatures of the secondary batteries 31A, 31B, and 31C and the power conversion circuits 32A, 32B, and 32C. Even if the secondary batteries 31A, 31B, and 31C are capable being discharged, the increases in the temperatures of the secondary batteries 31A, 31B, and 31C cause the output currents IA, IB, and IC to stop. For example, in the case where one of the secondary batteries 31A, 31B, and 31C has a temperature higher than temperatures of the other secondary batteries, the period during which output current can be maintained is shortened due to the secondary battery with the high temperature.

In contrast, the control circuits 33A, 33B, and 33C in the second power supply device 12 according to this preferred embodiment calculate, based on measurement results from the temperature sensors 42, output sustainable times thold during which the output currents IA, IB, and IC can be output due to currents discharged from the secondary batteries 31A, 31B, and 31C, respectively. The control unit 60 performs control so that an output current from a battery unit with the shortest output sustainable time thold among the battery units 30A, 30B, and 30C is decreased. By decreasing the output current from a battery unit including a secondary battery with a high temperature, an increase in the temperature of the secondary battery can be suppressed, and the output sustainable time thold of the corresponding battery unit can be increased. Thus, the output sustainable times thold of all the battery units 30A, 30B, and 30C can be increased. Accordingly, efficient operation of power stored in the battery units 30A, 30B, and 30C can be achieved.

### Effects

As described above, in a preferred embodiment, effects described below can be achieved.

(1) The second power supply device 12 includes the three battery units 30A, 30B, and 30C that are connected in parallel and the control unit 60 that is connected to the battery units 30A, 30B, and 30C. The battery units 30A, 30B, and 30C include the secondary batteries 31A, 31B, and 31C, the power conversion circuits 32A, 32B, and 32C, and the control circuits 33A, 33B, and 33C, respectively. In each of the secondary batteries 31A, 31B, and 31C, the temperature sensor 42, the voltage sensor 43, and the current sensor 44 are provided. In each of the power conversion circuits 32A, 32B, and 32C, the temperature sensor 45, the voltage sensor 46, and the current sensor 47 are provided.

The control circuits 33A, 33B, and 33C output the signals SIA, SIB, and SIC indicating the amounts of the output currents IA, IB, and IC from the battery units 30A, 30B, and 30C, respectively. Furthermore, the control circuits 33A, 33B, and 33C receive the signal SI_max indicating the maximum value of the signals SIA, SIB, and SIC. Then, the control circuits 33A, 33B, and 33C control the power conversion circuits 32A, 32B, and 32C, respectively, in such a manner that level differences between the signals SIA, SIB, and SIC and the signal SI_max are less than or equal to comparison difference target values. Thus, the control circuits 33A, 33B, and 33C control the power conversion circuits 32A, 32B, and 32C in such a manner that the output currents IA, IB, and IC from the battery units 30A, 30B, and 30C are equal. As described above, the output currents IA, IB, and IC from the battery units 30A, 30B, and 30C are made equal. Thus, concentration of load on one or some of the battery units 30A, 30B, and 30C can be prevented, and excessive current in the battery units 30A, 30B, and 30C can be suppressed.

(2) The control circuits 33A, 33B, and 33C calculate, based on measurement results from the temperature sensors 42, output sustainable times thold during which the output currents IA, IB, and IC can be output due to currents discharged from the secondary batteries 31A, 31B, and 31C, respectively. The control unit 60 performs control so that an output current from a battery unit with the shortest output sustainable time thold among the battery units 30A, 30B, and 30C is decreased. By decreasing the output current from a battery unit including a secondary battery with a high temperature, an increase in the temperature of the secondary battery can be suppressed, and the output sustainable time thold of the corresponding battery unit can be increased. Thus, the output sustainable times thold of all the battery units 30A, 30B, and 30C can be increased. Accordingly, efficient operation of power stored in the battery units 30A, 30B, and 30C can be achieved.

(3) The control circuits 33A, 33B, and 33C calculate, based on measurement results from the temperature sensors 45, estimation times tdcdc up to the time when the circuit temperatures Tdcdc of the power conversion circuits 32A, 32B, and 32C reach the temperature increase protection value Tdcdc_max. Furthermore, the control circuits 33A, 33B, and 33C calculate estimation times tsoc up to the time when the charge quantities in the secondary batteries 31A, 31B, and 31C reach a lower limit value. Then, each of the control circuits 33A, 33B, and 33C sets the minimum value among the estimation times tcell, tdcdc, and tsoc as the output sustainable time thold. The control circuits 33A, 33B, and 33C transmit the output sustainable times thold to the control unit Thus, the time up to the time when output of the output current is stopped by a protection function for a temperature increase in each of the power conversion circuits 32A, 32B, and 32C can be increased, and efficient operation of stored power can be achieved. Furthermore, the time up to the time when output of the output current is stopped due to the decrease in the stored charge quantity of each of the secondary batteries 31A, 31B, and 31C can be calculated more accurately.

(4) The temperature increase temporal gradients ΔTcell and ΔTdcdc (Ibatt, SOH) are stored as internal parameters in the memory units 48 in the control circuits 33A, 33B, and 33C. With the use of the internal parameters mentioned above, computational load can be reduced. As a result, the control circuits 33A, 33B, and 33C and the control unit 60 are not required to be configured to be capable of performing high-speed processing. Furthermore, since an output current from a battery unit with a short output sustainable time thold can be controlled before the protection function in the battery unit starts to work, significant variations in the output current can be prevented or reduced.

(5) The control circuits 33A, 33B, and 33C transmit secondary battery voltage values Vdcdc_in of the secondary batteries 31A, 31B, and 31C acquired by the voltage sensors 43 to the control unit 60. The control unit 60 compares the secondary battery voltage values Vdcdc_in of the battery units 30A, 30B, and and in the case where there is a difference among the secondary battery voltage values Vdcdc_in, the control unit 60 performs control so that an output current from a battery unit with a low secondary battery voltage value Vdcdc_in is decreased. The secondary battery voltage value Vdcdc_in decreases due to factors such as a decrease in the amount of charge, increases in the DC resistance component DCR of the secondary batteries 31A, 31B, and 31C, an increase in the amount of drop of internal voltage caused by an increase in the amount of discharge, and the like. The DC resistance component DCR increases when temperatures of the secondary batteries 31A, 31B, and 31C are low or the secondary batteries 31A, 31B, and 31C are degraded. By controlling the output current from the battery unit in which the secondary battery voltage value Vdcdc_in of the secondary battery 31A, 31B, or 31C is decreased due to the factors mentioned above, efficient operation of stored power can be achieved.

(6) The control circuits 33A, 33B, and 33C calculate Joule losses Ploss of the secondary batteries 31A, 31B, and 31C, respectively. The control unit 60 compares the Joule losses Ploss of the battery units 30A, 30B, and 30C, and performs control so that an output current from a battery unit with a low Joule loss Ploss is decreased. The Joule losses Ploss are calculated based on the state of health of the secondary batteries 31A, 31B, and 31C and the cell temperatures Tcell of the secondary batteries 31A, 31B, and 31C. Thus, by controlling an output current from a battery unit with a high degradation level or with a high cell temperature Tcell, efficient operation of stored power can be achieved.

### Modifications

The preferred embodiments described above can be modified, for example, as described below. The preferred embodiments described above and modifications described below can be combined as long as there is no technical contradiction. In the modifications described below, elements or features that are common to the preferred embodiments described above will be denoted by the same signs as those used in the preferred embodiments described above, and explanation for those common elements or features will be omitted.

The configuration of the second power supply device 12 illustrated in FIG. 2 may be changed in an appropriate manner.

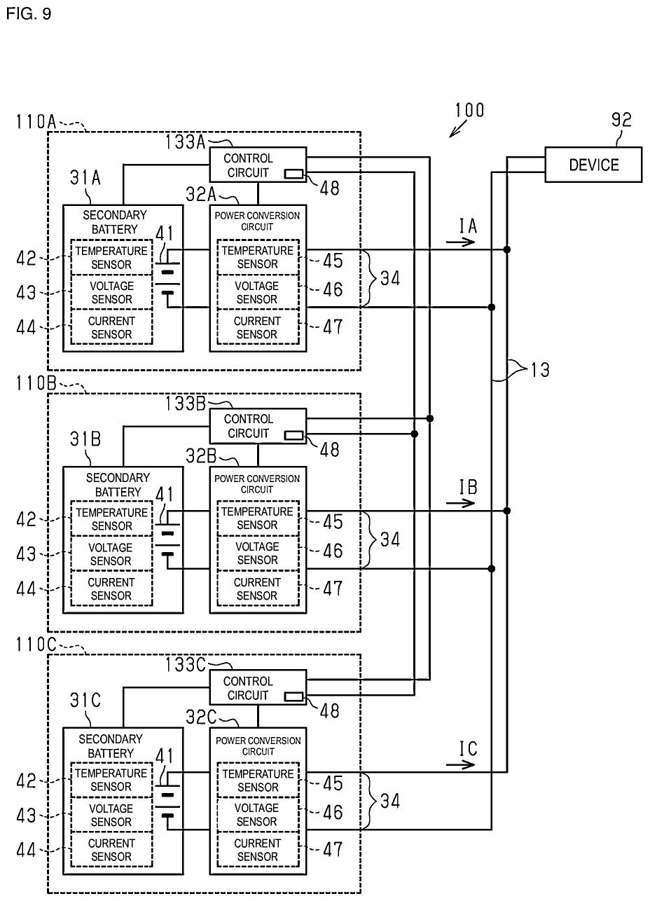

FIG. 9 illustrates the configuration of a second power supply device 100 according to a modification. The second power supply device 100 includes battery units 110A, 110B, and 110C including the secondary batteries 31A, 31B, and 31C, respectively, but does not include the control unit 60 illustrated in FIG. 2.

The battery units 110A, 110B, and 110C include the secondary batteries 31A, 31B, and 31C, the power conversion circuits 32A, 32B, and 32C, and control circuits 133A, 133B, and 133C, respectively.

The control circuits 133A and 133B in the battery units 110A and 110B have functions of the control circuits 33A and 33B in the battery units 30A and 30B illustrated in FIG. 2, respectively. The control circuit 133C in the battery unit 110C has a function of the control circuit 33C in the battery unit 30C illustrated in FIG. 2 and the function of the control unit 60. With the use of the battery unit 110C configured as described above, currents to be supplied from the battery units 110A, 110B, and 110C to the device 92 can be adjusted. Furthermore, the number of units of the second power supply device 100 can be decreased.

Instead of the control circuit 133C, any one of the control circuits 133A and 133B may also have the function of the control unit 60 illustrated in FIG. 1.

Both the control circuits 133A and 133B may also have the function of the control unit 60. Both the control circuits 133B and 133C may also have the function of the control unit 60. Both the control circuits 133A and 133C may also have the function of the control unit 60. All the control circuits 133A, 133B, and 133C may also have the function of the control unit 60. In the case where two or more control circuits also have the function of the control unit 60, setting may be set in such a manner, for example, one control circuit is caused to operate as a control unit by internal setting or one control circuit is caused to operate as a control unit by adjustment among all the control circuits.

Changes regarding elements necessary to set comparison difference target values may be made to the preferred embodiments described above in an appropriate manner.

For example, a comparison difference target value may be set only based on temperature. That is, the processing of steps 73, 74, 75, and 76 illustrated in FIG. 8 may be omitted. Furthermore, a comparison difference target value may be set only based on a secondary battery voltage value, and the processing of steps 71, 72, 75, and 76 may be omitted. Furthermore, a comparison difference target value may be set only based on internal loss, and the processing of steps 71, 72, 73, and 74 may be omitted.

Furthermore, a comparison difference target value may be set based on temperature and a secondary battery voltage value, and steps 75 and 76 may be omitted. Furthermore, a comparison difference target value may be set based on temperature and internal loss, and steps 73 and 74 may be omitted. Furthermore, a comparison difference target value may be set based on a secondary battery voltage value and internal loss, and steps 71 and 72 may be omitted.

In FIG. 3, the configuration in which the control circuits 33A, 33B, and 33C detect, using the diodes 49A, 49B, and 49C, the maximum level SI_max among the signal levels of the signals SIA, SIB, and SIC is illustrated. The control circuits 33A, 33B, and 33C may detect the maximum level SI_max by mutual transfer. For example, the control circuits 33A, 33B, and 33C, transmit the signals SIA, SIB, and SIC as digital signals to other control circuits. The control circuits 33A, 33B, and 33C define the maximum value among the received signals SIA, SIB, and SIC as the maximum level SI_max. With the configuration described above, current balance adjustment may be performed in such a manner that the output currents IA, IB, and IC from the battery units 110A, 110B, and 110C are equal. Furthermore, detection of the maximum level SI_max may be performed by the control unit 60.

In the preferred embodiments described above, the output currents IA, IB, and IC from the battery units 30A, 30B, and 30C are adjusted based on the output sustainable times thold. However, criteria for adjusting the output currents IA, IB, and IC are not limited to the output sustainable times thold. For example, temperatures of the battery units 30A, 30B, and 30C may be used as criteria. As the temperatures of the battery units 30A, 30B, and 30C, cell temperatures Tcell may be used, circuit temperatures Tdcdc may be used, or cell temperatures Tcell and circuit temperatures Tdcdc may be used. In the case where the temperature of a battery unit with the highest temperature among the measured temperatures exceeds a predetermined temperature threshold (for example, about 60° C.), control is performed so that an output current from the battery unit with the highest temperature is decreased and output currents from other battery units are increased so that the decrease in the output current from the battery unit with the highest temperature is compensated for. With this configuration, increasing output sustainable time and supplying electric power required by a load can be achieved at the same time with a simple configuration not including a device for performing calculation.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A power supply device comprising:
a plurality of battery units connected in parallel and each including a secondary battery;
a plurality of temperature sensors to measure temperatures of the plurality of battery units; and
a controller to control output currents from the plurality of battery units; wherein
the controller is configured or programmed to calculate, based on measurement results from the plurality of temperature sensors, output sustainable times during which the output currents are able to be output due to charge stored in the secondary batteries, and to perform control to decrease the output current from one of the plurality of battery units with a shortest output sustainable time.

2. The power supply device according to claim 1, wherein the controller is configured or programmed to perform control so that the output current from at least one of the battery units other than the battery unit with the shortest output sustainable time is increased.

3. The power supply device according to claim 1, wherein the controller is configured or programmed to perform control to increase the output current from one of the battery units with a longest output sustainable time.

4. The power supply device according to claim 1, further comprising a plurality of current sensors to measure the output currents from the plurality of battery units.

5. The power supply device according to claim 1, wherein the plurality of temperature sensors are operable to measure temperatures of the secondary batteries in the plurality of battery units.

6. The power supply device according to claim 5, wherein the controller is configured or programmed to estimate, as each of the output sustainable times, a time required for the temperature of the secondary battery to reach a temperature threshold or higher.

7. The power supply device according to claim 5, wherein
each of the plurality of battery units further includes a power conversion circuit to convert a current discharged from the secondary battery into the output current and a temperature sensor to measure a temperature of the power conversion circuit; and
the controller is configured or programmed to estimate a time required for the temperature of the secondary battery to reach a temperature threshold or higher and a time required for the temperature of the power conversion circuit to reach a circuit temperature threshold or higher, and to define a shorter one of an estimation time based on the temperature of the secondary battery and an estimation time based on the temperature of the power conversion circuit as the output sustainable time.

8. The power supply device according to claim 5, wherein
each of the plurality of battery units further includes a current sensor to measure a current discharged from the secondary battery; and
the controller is configured or programmed to estimate a time required for the temperature of the secondary battery to reach a temperature threshold or higher and a time required for a stored charge quantity based on a result of measurement of the current discharged from the secondary battery to reach a charge threshold or lower, and to define a shorter one of an estimation time based on the temperature of the secondary battery and an estimation time based on the stored charge quantity as the output sustainable time.

9. The power supply device according to claim 6, wherein
each of the plurality of battery units further includes a power conversion circuit to convert a current discharged from the secondary battery into the output current, a temperature sensor to measure a temperature of the power conversion circuit, and a current sensor to measure the current discharged from the secondary battery; and
the controller is configured or programmed to estimate the time required for the temperature of the secondary battery to reach the temperature threshold or higher, a time required for the temperature of the power conversion circuit to reach a circuit temperature threshold or higher, and a time required for a stored charge quantity based on a result of measurement of the current discharged from the secondary battery to reach a charge threshold or lower, and to define a shortest one of an estimation time based on the temperature of the secondary battery, an estimation time based on the temperature of the power conversion circuit, and an estimation time based on the stored charge quantity as the output sustainable time.

10. The power supply device according to claim 1, wherein
each of the plurality of battery units further includes a power conversion circuit to convert a current discharged from the secondary battery into the output current; and
the controller includes a control circuit that is provided in each of the plurality of battery units to control the corresponding power conversion circuit, and a control circuit controller connected to each of the plurality of battery units to instruct the corresponding control circuit to decrease the output current based on the output sustainable time.

11. The power supply device according to claim 1, wherein
each of the plurality of battery units further includes a power conversion circuit to convert a current discharged from the secondary battery into the output current; and
the controller includes a control circuit provided in each of the plurality of battery units to control the corresponding power conversion circuit.

12. The power supply device according to claim 5, wherein
the secondary battery includes a plurality of battery cells; and
the temperature sensor is operable to measure temperatures of the battery cells.

13. The power supply device according to claim 4, wherein
each of the plurality of battery units further includes a voltage sensor to measure a voltage of the secondary battery and a power conversion circuit to convert a current discharged from the secondary battery into the output current; and
in a case where a secondary battery voltage value of a secondary battery measured by the voltage sensor drops to a reference value, the controller is configured or programmed to compare secondary battery voltage values of the plurality of battery units, and control a corresponding power conversion circuit to decrease an amount of output current from one of the battery units with a lowest secondary battery voltage value.

14. The power supply device according to claim 4, wherein
each of the plurality of battery units further includes a voltage sensor to measure a voltage of the secondary battery and a power conversion circuit to convert a current discharged from the secondary battery into the output current; and
the controller is configured or programmed to calculate, based on measurement results from the current sensor and the voltage sensor, a Joule loss of the secondary battery, and to compare the Joule losses of the plurality of battery units, and in a case where there is a difference among the Joule losses, to control a corresponding power conversion circuit to decrease the amount of output current from one of the battery units with a highest Joule loss.

15. A power supply device comprising:
a plurality of battery units connected in parallel and each including a secondary battery;
a plurality of temperature sensors to measure temperatures of the plurality of battery units; and
a controller to control output currents from the plurality of battery units; wherein
the controller is configured or programmed to perform control to decrease the output current from one of the battery units with a highest measurement result among measurement results from the plurality of temperature sensors and to increase the output current from at least one of battery units other than the battery unit with the highest measurement result.

16. The power supply device according to claim 15, further comprising a plurality of current sensors to measure the output currents from the plurality of battery units.

17. The power supply device according to claim 15, wherein the plurality of temperature sensors are operable to measure temperatures of the secondary batteries in the plurality of battery units.

18. The power supply device according to claim 15, wherein
each of the plurality of battery units further includes a power conversion circuit to convert a current discharged from the secondary battery into the output current; and
the controller includes a control circuit that is provided in each of the plurality of battery units to control the corresponding power conversion circuit, and a control circuit controller connected to each of the plurality of battery units to instruct the corresponding control circuit to decrease the output current based on the output sustainable time.

19. The power supply device according to claim 15, wherein
each of the plurality of battery units further includes a power conversion circuit to convert a current discharged from the secondary battery into the output current; and
the controller includes a control circuit provided in each of the plurality of battery units to control the corresponding power conversion circuit.

20. The power supply device according to claim 17, wherein
the secondary battery includes a plurality of battery cells; and
the temperature sensor is operable to measure temperatures of the battery cells.
